(19) United States
(12) Patent Application Publication
(10) Pub. No.: US 2026/0244860 A1
(43) Pub. Date: Aug. 20, 2026

(54) MEMORY-EFFICIENT DECODING WITH KV CACHE COMPRESSION FOR LARGE LANGUAGE MODELS

(71) Applicant: INTERNATIONAL BUSINESS MACHINES CORPORATION, Armonk, NY (US)

(72) Inventors: Fatih Ilhan, Atlanta, GA (US); Gong Su, New York, NY (US)

(21) Appl. No.: 19/057,428

(22) Filed: Feb. 19, 2025

(51) Int. Cl. G06F 40/284; G06F 12/0802; G06T 1/60

(52) U.S. Cl. CPC G06F 40/284; G06F 12/0802; G06T 1/60

(57) ABSTRACT

A method, system, and computer program product configured to perform operations including: performing, during a decoding phase performed by a large language model (LLM), multi-head compression of key-value data in a cache; and performing partial decompression of the key-value data during the decoding phase, wherein the LLM is a decoder-based transformer model that is configured to generate an output based on an input by performing a tokenization phase, a prefill phase, the decoding phase, and a detokenization phase.

### BACKGROUND

Aspects of the present invention relate generally to artificial intelligence (AI) models and, more particularly, to decoder-based transformer models.

A decoder-based transformer model is a large language model (LLM) that can be used for generative AI tasks such as text generation. Inference in decoder-based transformer models is performed in phases including: tokenization and embedding; prefill (or initiation); decoding (or completion or generation); and detokenization.

### SUMMARY

In a first aspect of the invention, there is a method including: performing, during a decoding phase performed by a large language model (LLM), multi-head compression of key-value data in a cache; and performing partial decompression of the key-value data during the decoding phase, wherein the LLM is a decoder-based transformer model that is configured to generate an output based on an input by performing a tokenization phase, a prefill phase, the decoding phase, and a detokenization phase.

In another aspect of the invention, there is a computer program product comprising one or more computer-readable storage media and program instructions stored on the one or more computer-readable storage media to perform operations comprising: performing, during a decoding phase performed by a large language model (LLM), multi-head compression of key-value data in a cache; and performing partial decompression of the key-value data during the decoding phase, wherein the LLM is a decoder-based transformer model that is configured to generate an output based on an input by performing a tokenization phase, a prefill phase, the decoding phase, and a detokenization phase.

In another aspect of the invention, there is a computer system comprising a processor set, one or more computer-readable storage media, and program instructions stored on the one or more computer-readable storage media to cause the processor set to perform operations comprising: performing, during a decoding phase performed by a large language model (LLM), multi-head compression of key-value data in a cache; and performing partial decompression of the key-value data during the decoding phase, wherein the LLM is a decoder-based transformer model that is configured to generate an output based on an input by performing a tokenization phase, a prefill phase, the decoding phase, and a detokenization phase.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a diagram of an exemplary text generation task performed by a decoder-based transformer model in accordance with aspects of the present invention.

FIG. 4 shows a diagram of a caching technique in accordance with aspects of the present invention.

FIG. 5 shows a flowchart of an exemplary method of operations including those in performed a single decoding step in a caching technique in accordance with aspects of the present invention.

FIG. 6 shows pseudocode of an exemplary algorithm for operations performed in an attention block during a decoding step in the caching technique in accordance with aspects of the present invention.

FIG. 7 shows a flowchart of an exemplary method in accordance with aspects of the present invention.

### DETAILED DESCRIPTION

Aspects of the present invention relate generally to AI models and, more particularly, to decoder-based transformer models. Large language models (LLMs) have recently achieved remarkable success in text understanding/generation tasks, but they remain prohibitively expensive to deploy, especially for tasks requiring long context, such as in dialogue systems, summarization, or story writing. A significant amount of temporary state information, known as the key-value (KV) cache, is typically stored in graphics processing unit (GPU) memory along with the model parameters, and this storage requirement increases linearly with the sequence length and batch size.

In an attention block of a decoder-only transformer-based LLM architecture, a prefill phase includes computing query, key, and value vectors for each input token. After obtaining the first output vector, the generated output is appended to the input and processed through the network to get the next output. This decoding phase continues until an end-of-sequence (EOS) or length limit is reached. In the decoding phase, key and value vectors corresponding to previous tokens can be cached to prevent unnecessary re-computation. This process, called KV (key-value) caching, reduces the computation during a single generation step but results in fetching an ever-growing KV cache only to perform vector-to-matrix operations. This may lead to more time being spent loading the cache to GPU memory rather than in the computation itself, causing a problem of underutilization of the compute capacity and therefore a low-cost efficiency.

One technique for addressing this problem is to store the KV cache on GPU memory. However, this technique creates a new problem in that it requires exceedingly large amount of GPU memory. For instance, a thirty billion (30B) parameter model with an input batch size of 128 and a sequence length of 1024 may require around 180 GB of KV cache, which is triple the model weight size at half precision. For longer context windows and models, the memory problem becomes more significant as the cache size is linear with sequence length.

Some techniques improve the efficiency of decoder-based transformer models by reducing attention computation complexity in space and time. A first technique reduces the attention memory and computation complexity by hash-bucketing similar tokens. A second technique speeds up attention score computation by reducing the number of reads and writes between GPU high-bandwidth memory and GPU static random-access memory through fused kernel implementations over tiles. These techniques may be used to improve efficiency of such models by reducing computation time, but they do nothing to address the memory problems described above and their cache size is still large.

Some other techniques improve the efficiency of decoder-based transformer models by utilizing different algorithms to evict tokens from KV cache based on heuristic criteria. A first KV cache eviction technique persistently keeps a window of recent tokens and evicts tokens from the rest of the cache based on accumulated attention scores. A second KV cache eviction technique counts how many times a token was seen as unimportant (e.g., had attention score lower than a certain threshold) and discards tokens with high counter values. A third KV cache eviction technique keeps special tokens, punctuation tokens, and recent tokens in the cache, and evicts the tokens from the remaining set based on attention scores. However, all these KV cache eviction techniques bring an implicit bias in terms of the relation between eviction probability and token position. For instance, the second technique is more likely to evict tokens at earlier positions whereas the first technique is more likely to evict tokens at middle positions. Moreover, all these techniques fail to significantly reduce the memory footprint of the KV cache without causing significant loss of information after token eviction as the number of hidden dimensions in cached vectors is still the same. While these techniques might provide modest gains in reducing the cache size, this reduction comes at the cost of decreased model quality. Therefore, a problem still exists in that there are no current techniques that reduce the cache size without hurting model output quality.

Implementations of the invention provide a solution to the aforementioned problem by introducing a KV cache efficiency technique including: (i) an eviction policy based on scaled accumulated attention scores; (ii) a multi-head compression algorithm using singular value decomposition (SVD) to reduce cache memory by up to 50%, enabling higher batch sizes for parallelization; and (iii) partial decompression to reduce latency overhead in single inference. In embodiments, the eviction policy involves keeping track of accumulated attention scores, the number of contributions for attention score computations, and the standard deviation of attention scores for past tokens. A sliding window of recent tokens is kept within the cache to preserve coherence in text generation. The eviction policy involves only evicting tokens from outside the window and based on a score computed after scaling the accumulated attention score by the number of contributions. The combination of using a window to preserve recent tokens and evicting based on scaled accumulation scores advantageously prevents position bias in the eviction policy and preserves model output quality. The multi-head cache compression using SVD advantageously reduces the memory cost by up to 50% without hurting model output quality. Furthermore, less memory allocated for the KV cache enables larger batch sizes and parallel computation, which can significantly reduce the total process time or longer context preservation for better model output quality. The partial decompression advantageously reduces decompression latency overhead by determining the critical tokens at the current timestep and only operating on those. In this manner, implementations of the invention provide an improvement in decoder-based transformer models by reducing the cache size without hurting model output quality.

In accordance with aspects of the invention, there is a method comprising: performing, during a decoding phase performed by a large language model (LLM), multi-head compression of key-value data in a cache; and performing partial decompression of the key-value data during the decoding phase, wherein the LLM comprises a decoder-based transformer model that is configured to generate an output based on an input by performing a tokenization phase, a prefill phase, the decoding phase, and a detokenization phase. By performing multi-head compression and partial decompression in this manner, implementations of the invention advantageously provide for reducing the memory cost incurred in running the LLM and reducing decompression latency without hurting model quality.

In embodiments of the method, the cache is in a memory in a computing device. In this manner, embodiments provide the reduced cache size and reduced latency in the memory of a computing device that is executing the LLM.

In embodiments of the method, the cache is in a memory in one or more graphics processing units (GPUs). In this manner, embodiments provide the reduced cache size and reduced latency for in the memory of a GPU that is executing the LLM.

In embodiments, the method further comprises evicting from the cache, and during the decoding phase, one or more tokens of a plurality of tokens based on scaled accumulated attention scores. In this manner, embodiments provide the benefit of even further reduced cache size while running the LLM.

In embodiments of the method, the cache includes the key-value data in the form of key vectors and value vectors associated with respective ones of the plurality of tokens, and the evicting comprises deleting from the cache the key vectors and value vectors associated with the one or more tokens of the plurality of tokens. In this manner, embodiments provide the benefit of reduced cache size for KV caching while running the LLM.

In embodiments, the method further comprises performing the evicting based on determining that a size of the data stored in the cache exceeds a threshold value. In this manner, embodiments provide the benefit of maintaining the memory cost at or below the reduced cache size.

In embodiments of the method, the evicting is based on respective positions of the plurality of tokens. In this manner, embodiments provide the benefit of preventing position bias in the eviction policy.

In embodiments of the method, the performing multi-head compression comprises compressing information shared across heads by combining values in the cache along a head axis. Doing so advantageously provides relatively high compression values since there is typically common information in these matrices.

In embodiments of the method, the performing multi-head compression further comprises reducing respective matrices in the cache into components by performing singular value decomposition. Utilizing SVD advantageously provides dimensionality reduction and optimal low-rank approximation that is usable for performing multi-head compression.

In embodiments of the method, the performing partial decompression comprises decompressing a subset of the key-value data based on variance of attention scores associated with respective ones of a plurality of tokens. Tracking the variance of attention scores generated for each token within the cache and only decompressing the ones with the highest variance advantageously reduces the number of tokens selected from the cache and reduces the cost of decompression operations.

In accordance with aspects of the invention, there is a computer program product comprising one or more computer-readable storage media and program instructions stored on the one or more computer-readable storage media to perform operations comprising: performing, during a decoding phase performed by a large language model (LLM), multi-head compression of key-value data in a cache; and performing partial decompression of the key-value data during the decoding phase, wherein the LLM comprises a decoder-based transformer model that is configured to generate an output based on an input by performing a tokenization phase, a prefill phase, the decoding phase, and a detokenization phase. By performing multi-head compression and partial decompression in this manner, implementations of the invention advantageously provide for reducing the memory cost incurred in running the LLM and reducing decompression latency without hurting model quality.

In embodiments, the operations further comprise evicting from the cache, and during the decoding phase, one or more tokens of a plurality of tokens based on scaled accumulated attention scores. In this manner, embodiments provide the benefit of even further reduced cache size while running the LLM while advantageously preventing position bias in the eviction policy.

In embodiments, the evicting is based on respective positions of the plurality of tokens in a recency window. In this manner, embodiments advantageously prevent position bias in the eviction policy.

In embodiments, the performing multi-head compression comprises: compressing information shared across heads by combining values in the cache along a head axis; and reducing respective matrices into components by performing singular value decomposition. Doing so advantageously provides relatively high compression values since there is typically common information in these matrices, and utilizing SVD advantageously provides dimensionality reduction and optimal low-rank approximation that is usable for performing multi-head compression.

In embodiments, the performing partial decompression comprises decompressing a subset of the key-value data based on variance of attention scores associated with respective ones of a plurality of tokens. Tracking the variance of attention scores generated for each token within the cache and only decompressing the ones with the highest variance advantageously reduces the number of tokens selected from the cache and reduces the cost of decompression operations.

In accordance with aspects of the invention, there is a computer system comprising a processor set, one or more computer-readable storage media, and program instructions stored on the one or more computer-readable storage media to cause the processor set to perform operations comprising: performing, during a decoding phase performed by a large language model (LLM), multi-head compression of key-value data in a cache; and performing partial decompression of the key-value data during the decoding phase, wherein the LLM comprises a decoder-based transformer model that is configured to generate an output based on an input by performing a tokenization phase, a prefill phase, the decoding phase, and a detokenization phase. By performing multi-head compression and partial decompression in this manner, implementations of the invention advantageously provide for reducing the memory cost incurred in running the LLM and reducing decompression latency without hurting model quality.

In embodiments, the operations further comprise evicting from the cache, and during the decoding phase, one or more tokens of a plurality of tokens based on scaled accumulated attention scores. In this manner, embodiments provide the benefit of even further reduced cache size while running the LLM while advantageously preventing position bias in the eviction policy.

In embodiments, the evicting is based on respective positions of the plurality of tokens in a recency window. In this manner, embodiments advantageously prevent position bias in the eviction policy.

In embodiments, the performing multi-head compression comprises: compressing information shared across heads by combining values in the cache along a head axis; and reducing respective matrices into components by performing singular value decomposition. Doing so advantageously provides relatively high compression values since there is typically common information in these matrices, and utilizing SVD advantageously provides dimensionality reduction and optimal low-rank approximation that is usable for performing multi-head compression.

In embodiments, the performing partial decompression comprises decompressing a subset of the key-value data based on variance of attention scores associated with respective ones of a plurality of tokens. Tracking the variance of attention scores generated for each token within the cache and only decompressing the ones with the highest variance advantageously reduces the number of tokens selected from the cache and reduces the cost of decompression operations.

Implementations of the invention are necessarily rooted in computer technology. For example, the step of performing multi-head compression of data in a cache memory as part of a decoding phase performed by an LLM in generating an output is computer-based and cannot be performed in the human mind. Using a trained LLM to generate an output involves accessing millions (or billions) of bytes of data from computer memory and utilizing that data in computations in near real time (e.g., only a few seconds). Given this scale and complexity, it is simply not possible for the human mind, or for a person using pen and paper, to perform the number of calculations involved in training and/or using an LLM.

More specifically, modern deep learning models, including large language models (LLMs) used for generative artificial intelligence (AI) tasks such as dialogue systems, summarization, and story writing, are built from artificial neural networks that comprise multiple layers of interconnected nodes called neurons. Each neuron has an activation function which is a mathematical operation performed on data received from the previous layer, whose output informs the input fed to the following layer. Classic feed-forward neural networks (FFNs) process information by progressively passing input data from neurons in one layer to neurons in the following layer until it reaches an outer layer where final predictions occur. Some neural network architectures incorporate additional elements, like the self-attention mechanisms of transformer models, that capture additional patterns and dependencies in input data. The connections between different layers and neurons are mediated by learnable model parameters which are variable weights and biases that amplify or diminish the influence a given part of the network's output has on other parts of the network. A deep learning model “learns” by adjusting these parameters, using optimization algorithms like gradient descent, in a way that increases the accuracy of its predictions. First generation Generative Pre-trained Transformer (GPT) LLMs, which debuted in the year 2018, typically include hundreds of millions of parameters (e.g., 117 million parameters). Second generation GPT LLMs, which debuted in the year 2019, typically include around a billion parameters (e.g., 1.5 billion parameters). Third generation GPT LLMs, which debuted in the year 2020, typically include tens to hundreds of billions of parameters (e.g., anywhere from 30 billion to 175 billion parameters). Fourth generation GPT LLMs, which debuted in the year 2023, are estimated to include trillions of parameters (e.g., 1.7 trillion parameters). Each parameter typically requires 2 bytes of computer memory for storage and usage with the trained model. Therefore, using a trained LLM to generate an output (e.g., as with dialogue systems, summarization, and story writing) involves accessing at least hundreds of millions (and possibly billions or trillions) of bytes of data from computer memory and utilizing that data in computations in near real time (e.g., only a few seconds). Given this scale and complexity, it is simply not possible for the human mind, or for a person using pen and paper, to perform the number of calculations involved in using a trained LLM to generate an output.

Implementations of the invention also improve the functioning of a computer system. As described above, implementations reduce the cache size used by an LLM via multi-head compression of the data store in the cache. This compression reduces the memory cost by up to 50% without hurting model output quality and, thus, represents an improvement in the functioning of the computer system executing the LLM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as cache compression code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

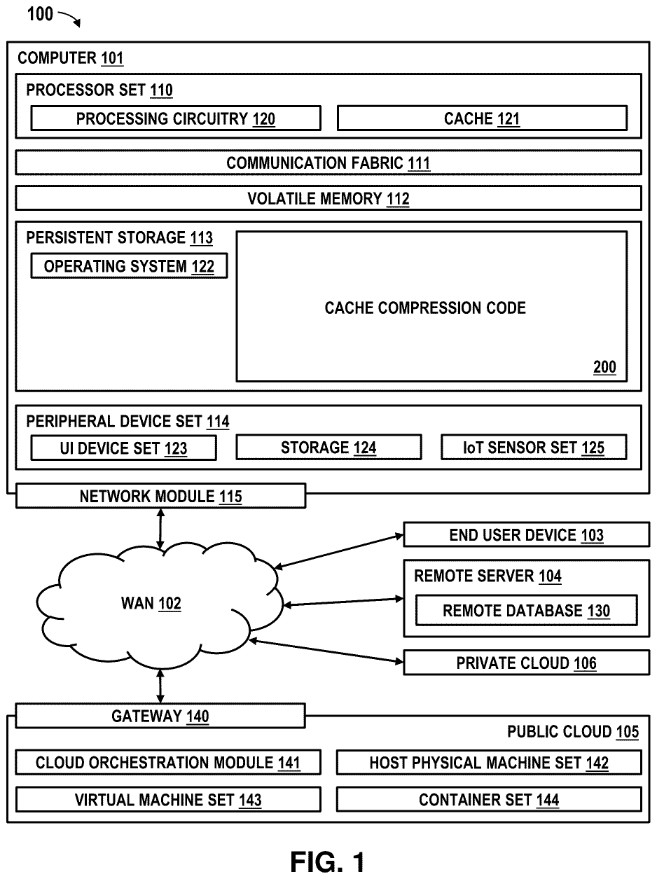

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

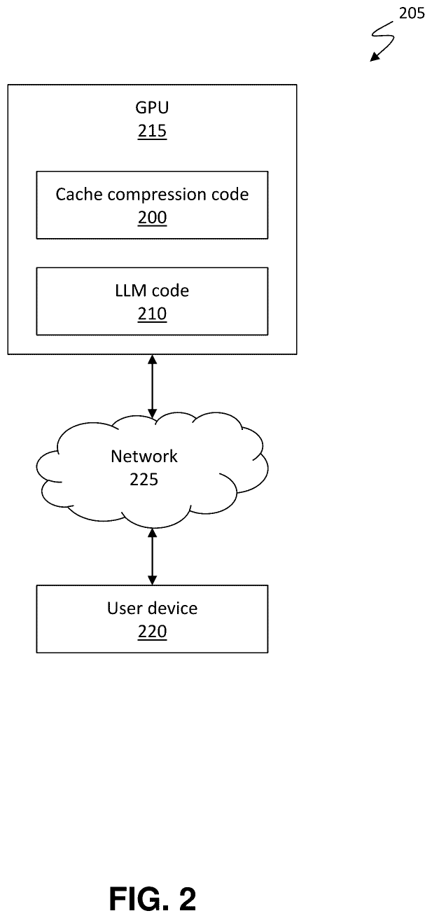

FIG. 2 shows a block diagram of an exemplary environment 205 in accordance with aspects of the invention. In embodiments, the environment 205 includes the cache compression code 200 of FIG. 1 and an LLM code 210 loaded to a GPU 215. In embodiments, the LLM code 210 defines a decoder-based transformer model that is configured to receive an input (e.g., from a user device 220 via a network 225) and generate an output based on the input. In various examples, the decoder-based transformer model defined by the LLM code 210 is a generative AI model that performs text understanding/generation tasks including tasks involving long context, such as in dialogue systems, summarization, or story writing. In embodiments, the GPU 215 corresponds to the processor set 110 of the computer 101 of FIG. 1 and the LLM code 210 is loaded into into the cache 121 of the processor set 110. In embodiments, the user device 220 comprises one or more instances of the EUD 103 of FIG. 1 and the network 225 comprises the WAN 102 of FIG. 1.

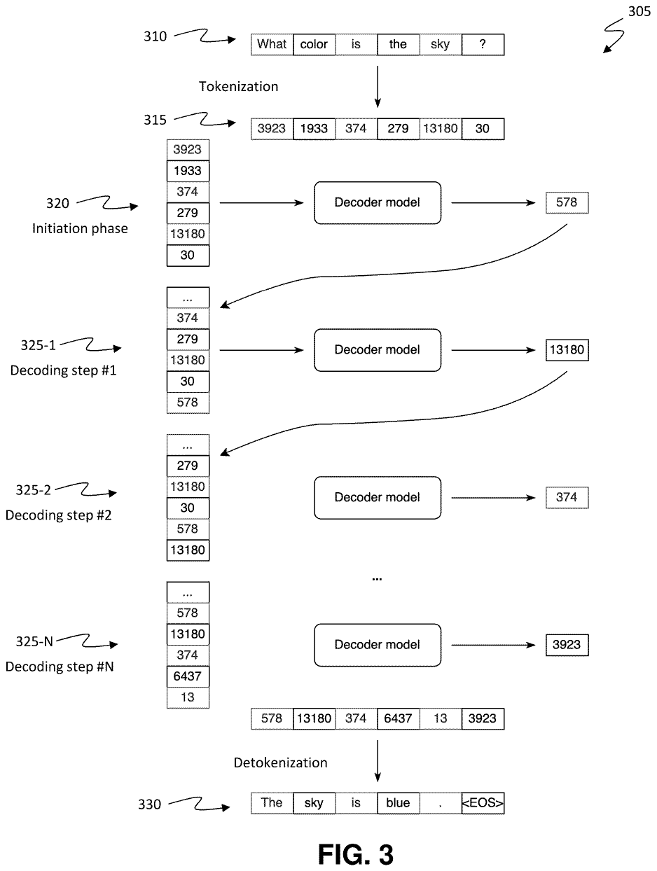

FIG. 3 shows a diagram of an exemplary text generation task 305 performed by the decoder-based transformer model defined by the LLM code 210 of FIG. 2. In this example, the model receives a text input 310 (e.g., from the user device 220 of FIG. 2). In a tokenization phase, the model converts individual words and punctuation of the text input 310 to tokens 315. In an initiation phase (also called a prefill phase), the model generates an initial input 320 based on the tokens 315 and generates an output based on the initial input 320. In a decoding phase comprising steps 325-1, 325-2, . . . , 325-N, the model generates a new input at each step by appending the output of the previous step to the input of the previous step, and the model then computes a new output based on the new input. This decoding phase continues until an EOS or a length limit is reached. In a detokenization stage, the model converts a final group of tokens to a text output 330 that may be returned to the requesting device (e.g., the user device 220 of FIG. 2).

With continued reference to FIG. 3, the model calculates a query vector, a key vector, and a value vector for each token of the initial input 320 in the prefill phase. After obtaining the first output vector during the prefill phase, the generated output is appended to the input and processed through the network to obtain the next output. During the decoding phase, the input gets longer with each step since the input for a current step is the input from the previous step appended with the output from the previous step. In an example of conventional KV caching, during the decoding phase the key vectors and value vectors corresponding to tokens in the previous step are cached in memory of the GPU so that these values are not recomputed at each step. This reduces the computation load at each step but causes the amount of data cached in the memory of the GPU to increase at each step. In one example, a 30B parameter model with an input batch size of 128 and a sequence length of 1024 may require around 180 GB of memory to store the KV cache data used in this caching technique.

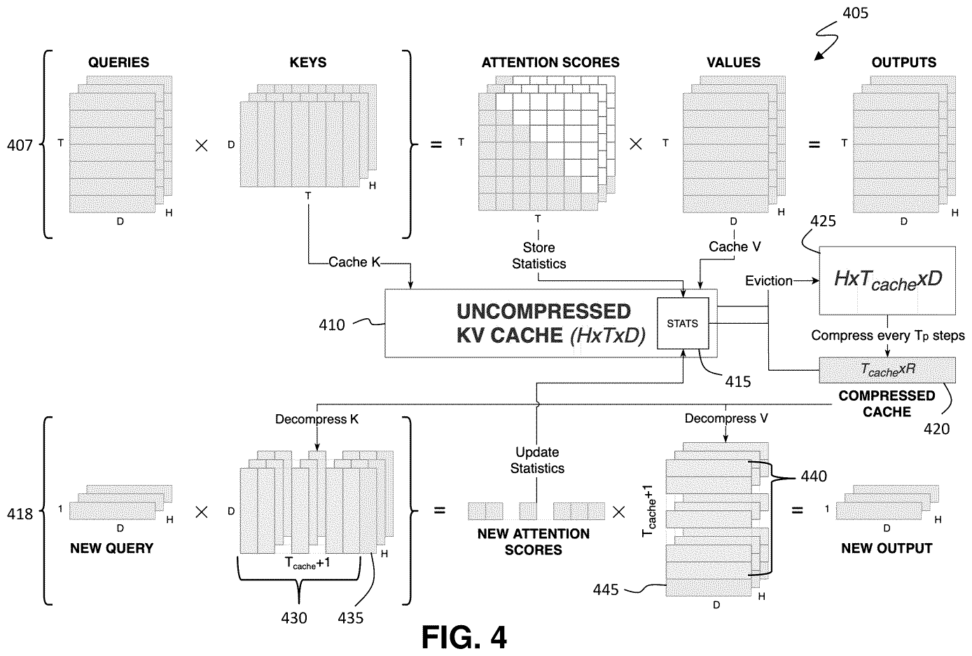

FIG. 4 shows a diagram 405 of a KV caching method in accordance with aspects of the invention. Steps of the method (also referred to as operations) may be carried out in the environment of FIG. 2 and are described with reference to elements depicted in FIG. 2. In embodiments, during a prefill phase 407, the model (e.g., a decoder-based transformer model defined by the LLM code 210 of FIG. 2) computes query vectors, key vectors, value vectors, and an initial output. In one example, there are T query vectors, each with D dimensions, where T is the number of tokens and D is the number of hidden dimensions of the model. In this example, query vectors are computed for each of H number of heads (e.g., attention heads) in the decoder-based transformer model. Respective key vectors are computed for each of the H number of heads and T tokens, where each key vector has D dimensions. Respective value vectors are computed for each of the H number of heads and T tokens, where each value vector has D dimensions. The query vectors and key vectors are used to calculate attention scores, which are used with the value vectors to calculate output vectors. In this example, values of the key vectors and values of the value vectors, calculated in the prefill phase, are cached in an uncompressed KV cache 410 stored in memory (e.g., cache memory) of the GPU 215. In this example, statistics associated with the attention scores, also calculated during the prefill phase, are stored as stats 415 with the uncompressed KV cache 410 in the memory of the GPU 215.

With continued reference to FIG. 4, a number of decoding steps are performed in a decoding phase 418 following the prefill phase 407. In embodiments, until the number of tokens in the uncompressed cache reaches the number Tp, the model performs these decoding steps using previously computed key vectors and value vectors retrieved from the uncompressed KV cache 410. During this first number of decoding steps, the key vectors and value vectors computed in each step are added to the uncompressed KV cache 410, and the attention score computed for each token is added to the stats 415. For example, an attention block in a decoder layer of the model may have weights for query, key, value and output computations, respectively. This attention block accepts the input activation vector at each decoding step. In order to perform the attention computation during decoding steps, all key and value vectors corresponding to past tokens are used. To prevent re-computation and reduce inference time, this past information is cached in the uncompressed KV cache 410 during these first number of decoding steps. At each of these decoding steps, after computing the query, key, and value vectors corresponding to the input for this decoding step, the computed key and value vectors are appended to the key and value matrices retrieved from the uncompressed KV cache 410, and the resulting matrices are used in attention score computations and to compute the output for this step.

In accordance with aspects of the invention, during the decoding phase, the cache compression code 200 periodically performs a compression operation following every T_{P} number of decoding steps, where the number T_{P} is referred to as the compression period. In embodiments, the compression operation comprises a multi-head compression using SVD as described herein. In embodiments, the compression operation compresses and stores KV cache data as a compressed cache 420 in the memory of the GPU 215 and flushes the uncompressed KV cache 410. During respective decoding steps following a compression, the compression code 200 decompresses (from the compressed cache 420) key vectors and value vectors needed for the current decoding step and uses these in computing query, key, and value vectors corresponding to the input for this decoding step. The computed key and value vectors corresponding to the input for this decoding step are appended to the key and value matrices retrieved from the cache, and the resulting matrices are used in attention score computations for this step and to compute the output for this step. The key and value vectors computed at this step are saved in the uncompressed KV cache 410. In this manner, the KV caching method adds data to the uncompressed KV cache 410 in decoding steps after a compression operation.

In embodiments, the attention scores computed at each decoding step are saved in the stats 415. In one example, the data stored in the stats 415 includes: a number of times each token has been used in a decoding step; an accumulated attention score for each token; and a variance of attention scores.

In embodiments, the compression code 200 periodically performing the compression operation reduces the amount of KV cache data that is saved in the memory of the GPU 215. This lower memory footprint of the KV cache data advantageously enables both processing queries in large batches to reduce total process time with parallelization and performing long-context inference in environments with very limited GPU memory. In various embodiments, the cache compression code 200 performs the compression operation by first combining cached matrices along the head axis to compress information shared across heads for higher compression rates instead of separately compressing the cached matrices of each head. The cache compression code 200 then performs low-rank singular value decomposition (SVD) to reduce each matrix within the cache into two low-rank components: K≈K′Dₖ, and V≈V′Dᵥ, where K′∈R^{T×Rk} (compressed key cache), Dₖ∈R^{Rk×HD} (key decompression matrix) and V′∈R^{T×Rv} (compressed value cache), Dv∈R^{Rv×HD} (value decompression matrix), where Rk, Rv are the corresponding rank values for SVD operations over key and value matrices. In embodiments, the corresponding rank values are selected based on the explained variance ratio.

SVD is the factorization of a matrix into the product of three matrices. SVD enables operations including dimensionality reduction and optimal low-rank approximation, which provide for simplifying a complex matrix by focusing on its most significant components. Embodiments use SVD to reduce the size of the input matrix from T*D*P to (T*R+R*D)*P where P is the number of bits of precision, D is the dimensionality of each token in the model (e.g., the number of hidden dimensions), T is the sequence length (e.g., the number of tokens), and R is the SVD rank. In embodiments, the value of rank R used in the multi-head compression is defined such that the explained variance ratio for key/value matrices is 90% or greater.

In a first exemplary use case, SVD-based compression is performed on heads individually in a test LLM with 40 heads, 128 hidden dimensions, and at a sequence length (number of tokens in each batch) of 1000. In this exemplary use case, the SVD rank is set at R=24 for compressing the key matrices. In this exemplary use case, for values of B=32, L=40, H=40, T=1000, D=128, R=24, and P=16, where L is the number of layers of the LLM, performing SVD-based compression is performed on heads individually results in compression of the key cache from 13.10 GB to 2.76 GB, which represents about 4.75 times compression of the key data stored in the KV cache.

Implementations of the invention perform multi-head compression by combining the information in the matrices of the multiple heads and then performing the SVD-based compression on the combined matrices. Doing so provides for relatively high compression values since there is typically common information in these matrices.

In a second exemplary use case, multi-head compression in accordance with aspects of the invention is performed in the same test model from the first exemplary use case (i.e., B=32, L=40, H=40, T=1000, D=128, and P=16), where L is the number of layers of the LLM. In this second exemplary use case, the key matrices of the 40 heads are combined and then SVD-based compression is performed on the combined matrices. In this second exemplary use case, an SVD rank value of R=64 is selected based on this R value being sufficient to achieve a 90% or greater explained variance ratio for the key matrices. In this second exemplary use case, performing multi-head compression in accordance with aspects of the invention results in compression of the key cache from 13.10 GB to 0.99 GB, which represents about 13.23 times compression of the key data stored in the KV cache.

With continued reference to FIG. 4 and in accordance with aspects of the invention, during the decoding phase, the cache compression code 200 performs an eviction operation represented at 425 based on determining that the size of the uncompressed KV cache 410 plus the size of the compressed cache 420 exceeds a predefined threshold amount. This may occur, for example, as the size of the uncompressed KV cache 410 grows between compression operations that occur every T_{P} number of decoding steps. In embodiments, the eviction operation is based on scaled accumulated attention scores of the tokens used in the decoding steps, as described herein. In embodiments, the cache compression code 200 calculates scaled accumulated attention scores for the tokens using information stored in the stats 415. In embodiments, the eviction operation deletes respective key vectors and value vectors from the uncompressed KV cache 410 and/or the compressed cache 420, wherein the respective key vectors and value vectors that are deleted are the key vectors and value vectors associated with a token that is selected for eviction.

Even though KV caching significantly reduces computation during decoding, the ever-growing size of cache is linear with the sequence length and can easily cause memory bottlenecks in tasks with long contexts. Offloading the cache to system memory causes high loading times from the system to GPU memory. KV eviction policies can reduce the size of the cache by removing the tokens with the lowest impact on model output quality based on attention scores-related criteria. In an eviction operation in accordance with aspects of the invention, the cache compression code 200 keeps (e.g., does not evict) the most recent Tr number of tokens in the cache to preserve coherent text generation. For example, if there are 250 tokens created in order from number 1 to number 250, and if Tᵣ=50, then the cache compression code 200 keeps tokens numbered 201 through 250 (i.e., does not select any of these for eviction during this eviction operation), and selects one or more of the tokens numbered 1 through 200 for eviction during this eviction operation. In this manner, the eviction operation is based in part on the relative positions of the tokens in order of creation of the tokens with the most recent Tr number of tokens being kept (i.e., not evicted) during an eviction operation. In embodiments, when selecting the one or more tokens for eviction during the eviction operation, the cache compression code 200 makes this selection based on scaled accumulated attention scores associated with each of the tokens. The scaled accumulated attention score for token t at decoding step T may be calculated using Expression 1.

$$Scaled accumulated attention score = \frac{{\sum }_{{t}^{′} = t}^{T} {A}_{{t}^{′} t}}{{\sum }_{{t}^{′} = t}^{T} {c}_{{t}^{′} t}} \qquad ( 1 )$$

In Expression 1, A_{t′t} is the attention score from token t′ to t and c_{t′t} is one if t-th token was used in the generation of t′-th token. In embodiments, the compression code 200 scales the accumulated attention score for a token with the number of contributions (e.g. if all cached tokens are used at each decoding step, by dividing with T−t) to eliminate position-related bias during the eviction unlike other eviction techniques that have a bias to evict early tokens or late tokens.

With continued reference to FIG. 4 and in accordance with aspects of the invention, during the decoding phase, the cache compression code 200 performs partial decomposition during the decoding phase. Compressed cache elements are decompressed (through multiplying with decompression matrices) before attention score computations. Even though the computation cost of compression operations is not significant as it is executed periodically for every T_{P} token, decompression introduces a latency overhead. Memory gains with compression can speed up process time if large batches are used, which compensates for the overhead thanks to parallel processing. However, in the single inference scenario, latency can increase up to 30% depending on batch size and context length.

Embodiments recognize that not every cached token is equally important at each decoding step. Based on this, the cache compression code 200 performs partial decompression to reduce the time spent during decompression operations. In embodiments, the eviction policy is used to determine which tokens to keep, and the partial decompression is used to select which tokens to use at a specific decoding step during the decoding phase. To achieve this, the cache compression code 200 tracks the variance of attention scores generated for each token within the cache and only decompresses the ones with the highest variance. Reducing the number of tokens selected from the cache directly reduces the cost of decompression operations.

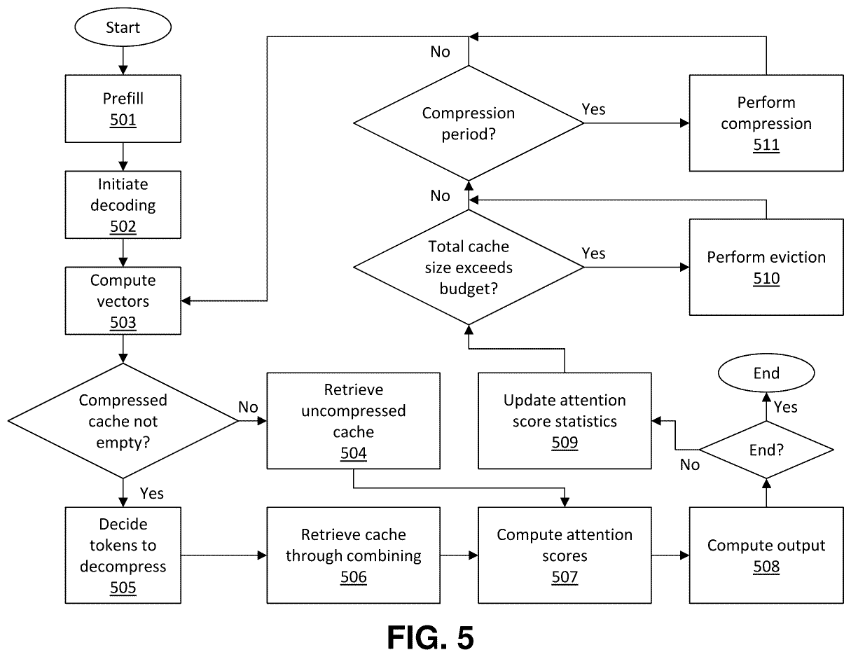

FIG. 5 shows a flowchart of an exemplary method of operations including those in performed a single decoding step in the KV caching technique in accordance with aspects of the invention. Steps of the method (also referred to as operations) may be carried out in the environment of FIG. 2 and are described with reference to elements depicted in FIG. 2.

At step 501, based on receiving an input (such as input 310 of FIG. 3), the model (e.g., a decoder-based transformer model defined by the LLM code 210 of FIG. 2) performs tokenization and the prefill phase. This may include obtaining the uncompressed KV cache through computing and storing the key and value vectors corresponding to the input tokens, and computing the first output token. At step 502 the model initiates the decoding phase through feeding the first output token as input to the LLM. At step 503 the model computes the query, key, and value vectors for the input token and pushes the computed key and value data into the uncompressed cache (e.g., the uncompressed KV cache 410 of FIG. 4).

Following step 503 the cache compression code 200 determines whether the compressed cache (e.g., the compressed cache 420 of FIG. 4) is not empty. The method proceeds to step 504 if the compressed cache is empty and proceeds to step 505 if the compressed cache is not empty.

At step 504 the model retrieves previously computed key and value data into the uncompressed cache (e.g., since the compressed cache is empty). In embodiments, step 504 occurs during a first number of decoding steps until the number of tokens in the uncompressed cache reaches Tₚ. After the first compression operation, the method follows the path to step 505 during each subsequent decoding step since the compressed cache is no longer empty.

At step 505 the cache compression code 200 decides which tokens to decompress from the compressed cache based on attention score variance. At step 506 the cache compression code 200 retrieves cached key and value vectors by combining data from the uncompressed cache and data from the compressed cache. In embodiments, steps 505 and 506 comprise the cache compression code 200 obtaining cached key and value vectors from the compressed cache by performing partial decompression based on attention score variance as described with respect to FIG. 4. To the extent that any of the key and value vectors are currently stored in the uncompressed cache, steps 505 and 506 comprise the cache compression code 200 obtaining some values from the uncompressed cache, obtaining other values from the compressed cache via partial decompression based on attention score variance, and creating the key and value matrices by combining the values retrieved from the different caches.

At step 507 the model computes attention scores for each of the tokens used in the current decoding step, and at step 508 the model computes the output for this decoding step. Following step 508 the model determines whether the generation process has reached an end. This may be performed by detecting an output length reaches a limit or by detecting an EOS token is reached. If the generation process has ended, then the model performs detokenization and provides the output to the requesting device (e.g., as shown at 330 of FIG. 3). If the generation process has not ended, then at step 509 the model updates the attention score statistics (e.g., the stats 415 of FIG. 4).

In accordance with aspects of the invention, after computing an output during and decoding step and updating the attention score statistics from the decoding step, the cache compression code 200 determines whether the total cache size exceeds a budget. In embodiments, the total cache size is the size (e.g., amount) of KV cache data stored in the uncompressed cache plus the size (e.g., amount) of KV cache data stored in the uncompressed cache, and the budget is a predefined maximum size (e.g., amount) of KV cache data that may be stored in the memory of the GPU. If the total cache size exceeds the budget, then at step 510 the cache compression code 200 performs an eviction operation in the manner described herein. For example, the cache compression code 200 selects one or more tokens for eviction based on token position and scaled accumulated attention score, and the cache compression code deletes from cache the key-value pairs associated with selected one or more tokens.

In accordance with aspects of the invention, after computing an output during and decoding step and updating the attention score statistics from the decoding step, the cache compression code 200 also determines whether the cache compression period has been reached. In embodiments, the cache compression period is the number T_{P} as described at FIG. 4. If the cache compression period has been reached after a particular decoding step, then at step 511 the cache compression code performs multi-head cache compression using SVD as described herein.

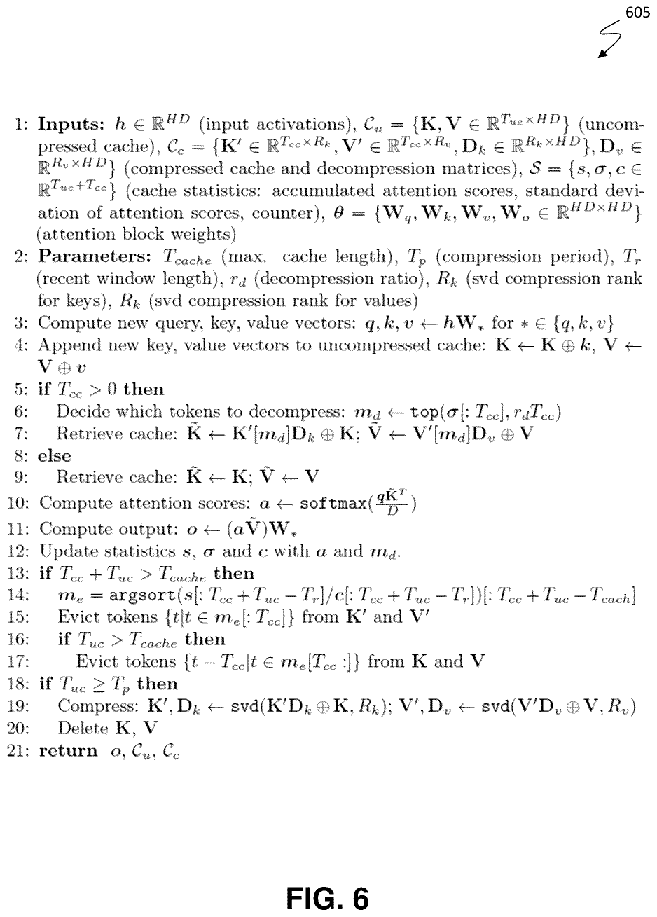

FIG. 6 shows pseudocode 605 of an exemplary algorithm for operations performed in an attention block during a decoding step in the KV caching technique in accordance with aspects of the invention. In embodiments, in decoding steps before cache eviction and compression is performed (i.e., the compressed cache is empty), KV data is stored in uncompressed cache containing the key and value vectors of all past tokens. After computing the query, key and value vectors corresponding to input (line 3 of the pseudocode 605), the computed key and value vectors are appended to the matrices retrieved from the uncompressed cache (line 4 of the pseudocode 605). If compression has already been performed before any decoding step, then the cache compression code 200 determines which tokens to decompress based on the standard deviation of attention scores and combine these tokens with the uncompressed cache after decompression (lines 5-7 of the pseudocode 605). After computing the attention scores (line 10 of the pseudocode 605) and output (line 11 of the pseudocode 605), the cache compression code 200 updates the statistics (accumulated attention scores, counters, and the standard deviation of attention scores) of tokens used in attention score computation (line 12 of the pseudocode 605). Then at any decoding step, if the total cache length has exceeded the limit, then the cache compression code 200 performs the eviction operation to evict the tokens with the lowest scaled accumulated attention scores, the tokens for eviction being selected from outside the recent cache window (lines 13-17 of the pseudocode 605). After the eviction, the cache compression code 200 performs multi-head compression over the key and value matrices (lines 18-19 of the pseudocode 605). After compression, the uncompressed cache is released from memory (line 20 of the pseudocode 605) and starts to be filled in the next decoding steps until the compression period is reached again, at which point the cache compression code 200 performs compression over the whole cache again. In embodiments, the output, the compressed cache, and the uncompressed cache are returned for usage in future decoding steps (line 21 of the pseudocode 605).

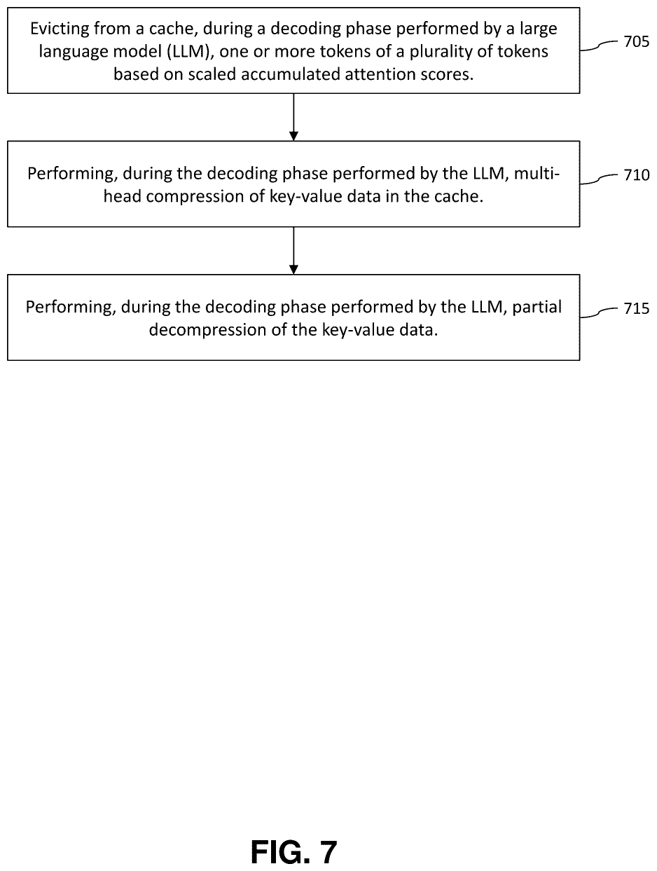

FIG. 7 shows a flowchart of an exemplary method in accordance with aspects of the present invention. Steps of the method (also referred to as operations) may be carried out in the environment of FIG. 2 and are described with reference to elements depicted in FIG. 2.

At step 705 the system evicts from a cache, during a decoding phase performed by a large language model (LLM), one or more tokens of a plurality of tokens based on scaled accumulated attention scores. In embodiments, the evicting may be based on determining that a total cached size exceeds a budget, as described with respect to FIG. 5. In embodiments, and as described herein, the evicting comprises deleting from the cache the key vectors and value vectors associated with the one or more tokens selected for eviction from a plurality of tokens. The tokens may be selected for eviction based on scaled accumulated attention scores of the tokens and also based on respective positions of the plurality of tokens.

At step 710 the system performs, during the decoding phase performed by the LLM, multi-head compression of key-value data in the cache. In embodiments, and as described herein, the multi-head compression comprises compressing information shared across heads by combining values in the cache along a head axis and further comprises further comprises reducing respective matrices in the cache into components by performing singular value decomposition.

At step 715 the system performs, during the decoding phase performed by the LLM, partial decompression of the key-value data. In embodiments, and as described herein, the partial decompression comprises decompressing a subset of the key-value data based on variance of attention scores associated with respective ones of a plurality of tokens.

In accordance with the foregoing description, implementations may be used to provide a method for efficient KV cache management for a long-context LLM inference system comprised of a computer with a GPU performing inference with the decoder-based LLM and input text. The method may comprise: the GPU receiving an input text; computing the first output token and caching key-value vectors in the prefill phase; performing cache eviction, cache compression, and cache decompression during the decoding phase; and generating text until stopping criteria is met. The method may further comprise: loading the specified LLM to the GPU; computing query, key, and value vectors for each input token through attention blocks and feedforward networks at each model layer (e.g., in the prefill phase); and generating the first output token (e.g., which is used as the first token of the decoding phase). The method may further comprise: storing the computed key and value vectors as KV cache on the global GPU memory; and computing the cache statistics (mean and variance of attention scores per token, number of contributions per token) for each token in the KV cache and storing alongside the KV cache. In embodiments of the method, the decoding step may be performed at plural times at each layer. In embodiments of the method, the query, key, and value vectors corresponding to the input token are computed. In embodiments of the method, the computed key and value matrices are appended to the key and value matrices retrieved from the uncompressed cache. In embodiments of the method, if the compressed cache is not empty, cache decompression is performed and comprises: deciding which tokens to decompress based on selecting the top tokens with the highest variance in attention scores; decompressing selected tokens through multiplication with a corresponding decompression matrix; and retrieving the cache through concatenating decompressed cache elements and uncompressed cache. In embodiments of the method, the attention scores are computed using the retrieved key cache and computed query vector. In embodiments of the method, the layer output is computed using the retrieved value cache and computed attention scores. In embodiments of the method, if the total size of compressed and uncompressed cache exceeds the available limit, then cache eviction is performed. In embodiments of the method, a number of the tokens with the lowest scaled accumulated attention scores are evicted, where these tokens are not selected from a predefined number of last tokens within a recency window. In embodiments of the method, if the size of the uncompressed cache exceeds the compression period, then cache compression is performed, further comprising the steps of: combining the cached vectors along different transformer heads; and applying SVD to obtain low-rank components of key and value matrices.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
performing, during a decoding phase performed by a large language model (LLM), multi-head compression of key-value data in a cache; and
performing partial decompression of the key-value data during the decoding phase,
wherein the LLM comprises a decoder-based transformer model that is configured to generate an output based on an input by performing a tokenization phase, a prefill phase, the decoding phase, and a detokenization phase.

2. The method of claim 1, wherein the cache is in a memory in a computing device.

3. The method of claim 1, wherein the cache is in a memory in one or more graphics processing units (GPUs).

4. The method of claim 1, further comprising evicting from the cache, and during the decoding phase, one or more tokens of a plurality of tokens based on scaled accumulated attention scores.

5. The method of claim 4, wherein:
the cache includes the key-value data in the form of key vectors and value vectors associated with respective ones of the plurality of tokens; and
the evicting comprises deleting from the cache the key vectors and value vectors associated with the one or more tokens of the plurality of tokens.

6. The method of claim 4, further comprising performing the evicting based on determining that a size of the data stored in the cache exceeds a threshold value.

7. The method of claim 4, wherein the evicting is based on respective positions of the plurality of tokens.

8. The method of claim 1, wherein the performing multi-head compression comprises compressing information shared across heads by combining values in the cache along a head axis.

9. The method of claim 8, wherein the performing multi-head compression further comprises reducing respective matrices in the cache into components by performing singular value decomposition.

10. The method of claim 1, wherein the performing partial decompression comprises decompressing a subset of the key-value data based on variance of attention scores associated with respective ones of a plurality of tokens.

11. A computer program product comprising:
one or more computer-readable storage media; and
program instructions stored on the one or more computer-readable storage media to perform operations comprising:
performing, during a decoding phase performed by a large language model (LLM), multi-head compression of key-value data in a cache; and
performing partial decompression of the key-value data during the decoding phase,
wherein the LLM comprises a decoder-based transformer model that is configured to generate an output based on an input by performing a tokenization phase, a prefill phase, the decoding phase, and a detokenization phase.

12. The computer program product of claim 11, further comprising evicting from the cache, and during the decoding phase, one or more tokens of a plurality of tokens based on scaled accumulated attention scores.

13. The computer program product of claim 12, wherein the evicting is based on respective positions of the plurality of tokens in a recency window.

14. The computer program product of claim 11, wherein the performing multi-head compression comprises:
compressing information shared across heads by combining values in the cache along a head axis; and
reducing respective matrices into components by performing singular value decomposition.

15. The computer program product of claim 11, wherein the performing partial decompression comprises decompressing a subset of the key-value data based on variance of attention scores associated with respective ones of a plurality of tokens.

16. A computer system comprising:
a processor set;
one or more computer-readable storage media; and
program instructions stored on the one or more computer-readable storage media to cause the processor set to perform operations comprising:
performing, during a decoding phase performed by a large language model (LLM), multi-head compression of key-value data in a cache; and
performing partial decompression of the key-value data during the decoding phase,
wherein the LLM comprises a decoder-based transformer model that is configured to generate an output based on an input by performing a tokenization phase, a prefill phase, the decoding phase, and a detokenization phase.

17. The computer system of claim 16, further comprising evicting from the cache, and during the decoding phase, one or more tokens of a plurality of tokens based on scaled accumulated attention scores.

18. The computer system of claim 17, wherein the evicting is based on respective positions of the plurality of tokens in a recency window.

19. The computer system of claim 16, wherein the performing multi-head compression comprises:
compressing information shared across heads by combining values in the cache along a head axis; and
reducing respective matrices into components by performing singular value decomposition.

20. The computer system of claim 16, wherein the performing partial decompression comprises decompressing a subset of the key-value data based on variance of attention scores associated with respective ones of a plurality of tokens.
